(19) United States
(12) Patent Application Publication
(10) Pub. No.: US 2024/0284043 A1
(43) Pub. Date: Aug. 22, 2024

(54) APPARATUS, CONTROL METHOD FOR APPARATUS, AND STORAGE MEDIUM

(71) Applicant: CANON KABUSHIKI KAISHA, TOKYO (JP)

(72) Inventors: TAKAYUKI AKAGUMA, TOKYO (JP); TOMOHIRO NISHIYAMA, TOKYO (JP)

(21) Appl. No.: 18/443,099

(22) Filed: Feb. 15, 2024

(30) Foreign Application Priority Data
Feb. 21, 2023 (JP) 2023-024899

(51) Int. Cl. H04N 23/66; G06V 10/74; H04N 23/611; H04N 23/63

(52) U.S. Cl. CPC H04N 23/66; G06V 10/761; H04N 23/611; H04N 23/633

(57) ABSTRACT

An apparatus includes an image sensor, an operation member configured to receive an instruction, a communicator configured to communicate with another apparatus, and one or more processors that execute a program stored in a memory to function as an acquisition unit configured to acquire an image, a detection unit configured to detect objects from the image, and a selection unit configured to select at least one of the objects as a main object, wherein, in a case where the selected main object is detected in the another apparatus, the communicator also transmits the instruction issued to the operation member to the another apparatus.

### BACKGROUND

### Technical Field

The present disclosure relates to an imaging apparatus that controls a plurality of cameras and an imaging system using the same.

### Description of the Related Art

In imaging, for example, a competitive game such as a soccer game using cameras, there may be a case where a camera for remote imaging (hereinbelow referred to as remote imaging camera) is installed near a goal to perform remote imaging therefrom, and at the same time a photographer performs imaging from a different position using a handheld camera for imaging (hereinbelow referred to as handheld imaging camera).

In such use cases of imaging, focus adjustment of the remote imaging camera is often manually performed. This is because it is difficult for the photographer to immediately recognize and correct an imaging status of the remote imaging camera while operating the handheld camera at the same time. In such imaging, the photographer cannot determine whether the remote imaging camera is capturing images of a desired object, using the handheld imaging camera, thus a large number of unnecessary images are often captured by the remote imaging camera. Japanese Patent Application Laid-Open No. 2010-124263 discusses an imaging apparatus that, in a case where a plurality of cameras is used for imaging, acquires information about positions and directions of other cameras relative to an object, and instructs the other cameras to capture images of the object. Accordingly, it is possible to determine whether images of a desired object are being captured by a remote imaging camera using a handheld imaging camera.

However, with a method discussed in Japanese Patent Application Laid-Open No. 2010-124263, it is difficult to distinguish a case where the object is not captured within an angle of view of the remote imaging camera due to the existence of an obstacle between the object and the remote imaging camera, from other cases such as a case where autofocus (AF) fails.

### SUMMARY

According to an aspect of the present disclosure, an apparatus includes an image sensor, an operation member configured to receive an instruction, a communicator configured to communicate with another apparatus, and one or more processors that execute a program stored in a memory to function as an acquisition unit configured to acquire an image, a detection unit configured to detect objects from the image, and a selection unit configured to select at least one of the objects as a main object, wherein, in a case where the selected main object is detected in the another apparatus, the communicator also transmits the instruction issued to the operation member to the another apparatus.

Further features of the present disclosure will become apparent from the following description of exemplary embodiments with reference to the attached drawings.

### BRIEF DESCRIPTION OF THE DRAWINGS

FIG. 1 is a block diagram illustrating an interchangeable lens camera.

FIG. 2 is a schematic diagram illustrating an array of imaging pixels (and focus detection pixels) in an imaging element.

FIG. 3A is a plan view of the imaging element viewed from a light receiving surface side (+z side).

FIG. 3B is a cross-sectional view of the imaging element.

FIG. 4 is a diagram illustrating a correspondence relationship between a pixel structure and pupil division.

FIG. 5 is a diagram illustrating a correspondence relationship between the imaging element and pupil division.

FIG. 6 is a diagram illustrating a relationship of an image shift amount between detection signals.

FIG. 7 illustrates a use scene according to a first exemplary embodiment.

FIG. 8 is a flowchart illustrating processing performed by a handheld imaging camera according to the first exemplary embodiment.

FIG. 9A is a diagram illustrating a notification by image display according to the first exemplary embodiment.

FIG. 9B is a diagram illustrating a notification by an icon according to the first exemplary embodiment.

FIG. 10 is a flowchart illustrating processing performed by a remote imaging camera according to the first exemplary embodiment.

FIG. 11 is a flowchart illustrating processing performed by a remote imaging camera according to a second exemplary embodiment.

FIG. 12 is a flowchart illustrating processing performed by a handheld imaging camera according to the second exemplary embodiment.

### DESCRIPTION OF THE EMBODIMENTS

Exemplary embodiments of the present disclosure will be described in detail below with reference to the attached drawings. It is noted that the following exemplary embodiments are not intended to limit the scope of the present disclosure as encompassed by the appended claims. Although a plurality of characteristics is described in the exemplary embodiments, not all of these characteristics are essential to the present disclosure, and the plurality of characteristics may be arbitrarily combined. Further, the same or similar components are denoted by the same reference numerals in the attached drawings, and duplicate descriptions are omitted.

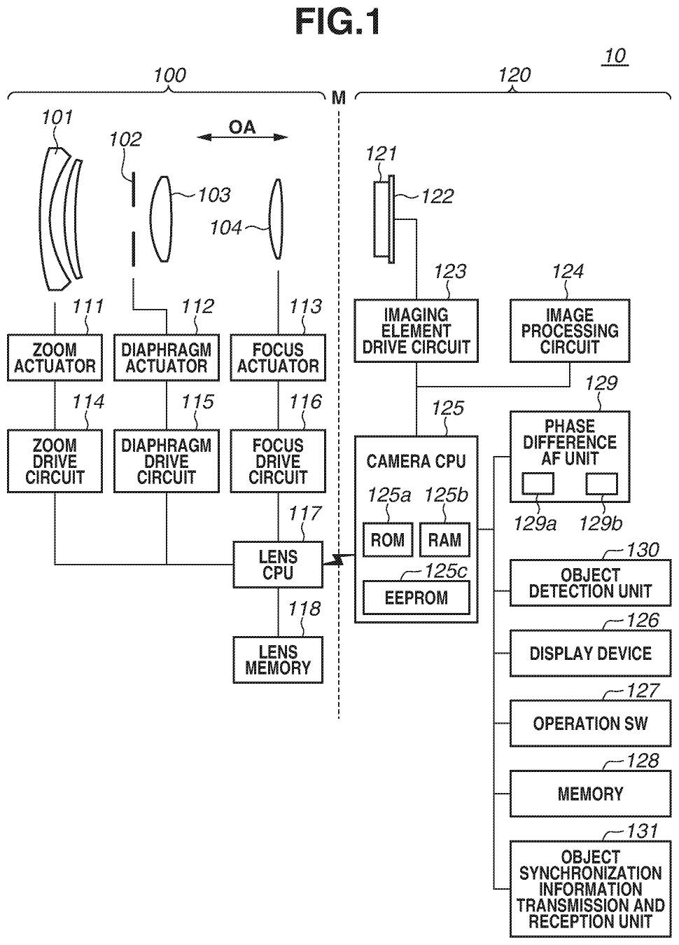

FIG. 1 is a diagram illustrating a configuration of an imaging apparatus 10 as an example of an apparatus according to a first exemplary embodiment of the present disclosure. In FIG. 1, the imaging apparatus 10 (single-lens reflex type digital camera with interchangeable lenses) is a camera system that includes a lens unit 100 (interchangeable lenses) and a camera body 120. The lens unit 100 is attachable to and detachable from the camera body 120 via a mount M illustrated by a dotted line in FIG. 1. However, the present exemplary embodiment is not limited to this configuration and can be applied to an imaging apparatus (a digital camera) in which a lens unit (an imaging optical system) and a camera body are integrally configured. Further, the present exemplary embodiment is not limited to a digital camera and can be applied to other imaging apparatuses such as a video camera.

The lens unit 100 includes a first lens unit 101, a diaphragm 102, a second lens unit 103, and a focus lens unit (hereinbelow simply referred to as “focus lens”) 104 as an optical system, and units that performs driving and control of the lens unit 100. As described above, the lens unit 100 is an imaging lens (the imaging optical system) that includes the focus lens 104 and forms an object image.

The first lens unit 101 is arranged at a tip end of the lens unit 100 and is held movable forward and backward in an optical axis direction OA. The diaphragm 102 adjusts an amount of light during imaging by adjusting its aperture diameter and also functions as a shutter to adjust an exposure time in still image capturing. The diaphragm 102 and the second lens unit 103 can integrally move in the optical axis direction OA and implement a magnification (zoom) function in an interlocked manner with the forward and backward movement of the first lens unit 101.

The focus lens 104 can move in the optical axis direction OA, and an object distance (focusing distance) on which the lens unit 100 focuses changes depending on its position. The position of the focus lens 104 in the optical axis direction OA is controlled, and thus focus adjustment (focus control) for adjusting the focusing distance of the lens unit 100 can be performed.

The lens unit 100 is driven and controlled by a zoom actuator 111, a diaphragm actuator 112, a focus actuator 113, a zoom drive circuit 114, a diaphragm drive circuit 115, a focus drive circuit 116, a lens central processing unit (CPU) 117, and a lens memory 118. The zoom drive circuit 114 drives the first lens unit 101 and the second lens unit 103 in the optical axis direction OA using the zoom actuator 111 and controls an angle of view of the optical system of the lens unit 100 (i.e., performs a zoom operation). The diaphragm drive circuit 115 drives the diaphragm 102 using the diaphragm actuator 112 and controls the aperture diameter and opening/closing operations of the diaphragm 102. The focus drive circuit 116 drives the focus lens 104 in the optical axis direction OA using the focus actuator 113 and controls the focusing distance of the optical system of the lens unit 100 (i.e., performs focus control). The focus drive circuit 116 also has a function as a position detection unit that detects a current position (a lens position) of the focus lens 104 using the focus actuator 113.

The lens CPU (a processor) 117 performs all calculations and control related to the lens unit 100 to control the zoom drive circuit 114, the diaphragm drive circuit 115, and the focus drive circuit 116. Further, the lens CPU 117 is connected to a camera CPU 125 via the mount M and communicates a command and data therewith. For example, the lens CPU 117 detects the position of the focus lens 104 and notifies the camera CPU 125 of lens position information in response to a request therefrom. The lens position information includes information about the position of the focus lens 104 in the optical axis direction OA, a position and a diameter of an exit pupil in the optical axis direction OA in a state where the optical system is not moving, and a position and a diameter of a lens frame that limits a light flux of the exit pupil in the optical axis direction OA. Further, the lens CPU 117 controls the zoom drive circuit 114, the diaphragm drive circuit 115, and the focus drive circuit 116 in response to a request from the camera CPU 125. The lens memory 118 stores optical information necessary for automatic focus (AF) adjustment (AF control). The camera CPU 125 controls an operation of the lens unit 100 by executing a program stored in, for example, a built-in nonvolatile memory or the lens memory 118.

The camera body 120 includes an imaging element 122 and each unit that performs driving and control of the camera body 120. The imaging element 122 functions as an imaging unit that photoelectrically converts an object image (an optical image) formed through the lens unit 100 and outputs image data. According to the present exemplary embodiment, the imaging element 122 photoelectrically converts an object image formed through the imaging optical system (the lens unit 100) and outputs an imaging signal and a focus detection signal as image data. Further, according to the present exemplary embodiment, the imaging optical system is constituted by the first lens unit 101, the diaphragm 102, the second lens unit 103, and the focus lens 104.

The imaging element 122 is constituted by a complementary metal oxide semiconductor (CMOS) image sensor and its peripheral circuits, and includes m pixels in a horizontal direction and n pixels in a vertical direction (m and n are integers of two or more). The imaging element 122 according to the present exemplary embodiment also plays a role of a focus detection element, and has a pupil division function. The imaging element 122 includes a pupil division pixel that can perform focus detection using a phase difference detection method (phase difference AF), using image data (image signal). An image processing circuit 124 generates data for the phase difference AF and image data for display, recording and object detection based on the image data output from the imaging element 122.

The camera body 120 is driven and controlled by an imaging element drive circuit 123, the image processing circuit 124, the camera CPU 125, a display device 126, an operation switch group (operation SW) 127, a memory 128, a phase difference AF unit 129 (an imaging plane phase difference focus detection unit, or a control unit), an object detection unit 130, and an object synchronization information transmission and reception unit 131.

The imaging element drive circuit 123 controls the operation of the imaging element 122, and at the same time, performs analog-to-digital (A/D) conversion on the image signal (image data) output from the imaging element 122 and transmits the converted image signal to the camera CPU 125. The image processing circuit 124 performs general image processing performed in a digital camera, such as gamma conversion, color interpolation processing, and compression coding processing, on the image signal output from the imaging element 122.

The camera CPU 125 (a processor or a control device) performs all calculations and control related to the camera body 120. In other words, the camera CPU 125 controls the imaging element drive circuit 123, the image processing circuit 124, the display device 126, the operation switch group 127, the memory 128, the phase difference AF unit 129, the object detection unit 130, the object synchronization information transmission and reception unit 131, a vibration unit (not illustrated), and a speaker unit (not illustrated). The camera CPU 125 is connected to the lens CPU 117 via a signal line of the mount M and communicates a command and data with the lens CPU 117. The camera CPU 125 issues requests to the lens CPU 117 to acquire the lens position and to drive the lens at a predetermined drive amount. The camera CPU 125 also issues a request to the lens CPU 117 so as to acquire optical information unique to the lens unit 100 from the lens CPU 117.

The camera CPU 125 incorporates a read-only memory (ROM) 125a that stores a program for controlling an operation of the camera body 120, a random access memory (RAM) 125b (camera memory) that stores a variable, and an electrically erasable programmable read only memory (EEPROM) 125c that stores various parameters. Further, the camera CPU 125 executes various types of processing based on the program stored in the ROM 125a.

The display device 126 includes a liquid crystal display (LCD) and displays information regarding an imaging mode of the imaging apparatus 10, a preview image before imaging, a confirmation image after imaging, and a focus state display image at the time of focus detection. The operation switch group 127 includes a power supply switch, a release (imaging trigger) switch, a zoom operation switch, and an imaging mode selection switch, and the camera CPU 125 controls each unit in the camera body 120 based on an input operation performed by a user. The memory 128 (a recording unit) is an attachable and detachable flash memory that records a captured image.

The phase difference AF unit 129 performs focus detection processing using the phase difference detection method based on the image signal (signal for phase difference AF) of image data for focus detection acquired from the imaging element 122 and the image processing circuit 124. More specifically, the image processing circuit 124 generates a pair of image data, which is formed by light fluxes passing through a pair of pupil areas of the imaging optical system as data for focus detection, and the phase difference AF unit 129 detects a defocus amount based on an amount of shift between the pair of image data. In this way, the phase difference AF unit 129 according to the present exemplary embodiment performs the phase difference AF (imaging plane phase difference AF) based on an output of the imaging element 122 without using a dedicated AF sensor. According to the present exemplary embodiment, the phase difference AF unit 129 includes an acquisition unit 129a and a calculation unit 129b. An operation of each of these units is described below. At least either of the units (the acquisition unit 129a or the calculation unit 129b) of the phase difference AF unit 129 may be provided in the camera CPU 125. An operation of the phase difference AF unit 129 is described in detail below. The phase difference AF unit 129 functions as a focus control unit that controls the position of the focus lens 104 using a result of focus detection.

The object detection unit 130 stores dictionary data necessary for recognition of an object, such as a person, an animal and a vehicle, in advance in the memory 128 and performs object detection based on a signal acquired from the image processing circuit 124. A method for object detection performed by the object detection unit 130 may be other than the above-described method, and any known method capable of recognizing an object can be used. Further, the object detection unit 130 may be configured to detect and recognize an object that matches a pattern registered in advance in the object recognition processing. Examples of information registered in advance include information about a face associated with a specific individual, and the object detection unit 130 can determine the object by calculating a degree of matching between a feature amount of the registered face and a feature amount of the detected object. The information to be registered is stored in the memory 128 or an information registration unit (not illustrated).

The object synchronization information transmission and reception unit 131 has a function of transmitting synchronization information necessary for main object synchronization, such as image data and feature information of the object detected by the object detection unit 130 and information about the operation SW 127, to another imaging apparatus 10. The object synchronization information transmission and reception unit 131 also has a function of receiving synchronization information transmitted from another imaging apparatus. A communication method for transmitting and receiving data between cameras may be a wireless or wired method. A flow of processing performed by the object synchronization information transmission and reception unit 131 is described in detail below.

The vibration unit (not illustrated) has a function of vibrating the camera body 120 by being controlled by the camera CPU 125. The vibration unit can notify a user of a result of determination made by the camera using a vibration pattern.

The speaker unit (not illustrated) has a function of making a sound by being controlled by the camera CPU 125. The speaker unit 133 can notify a user of not only a result of determination made by the camera but also various information by a sound.

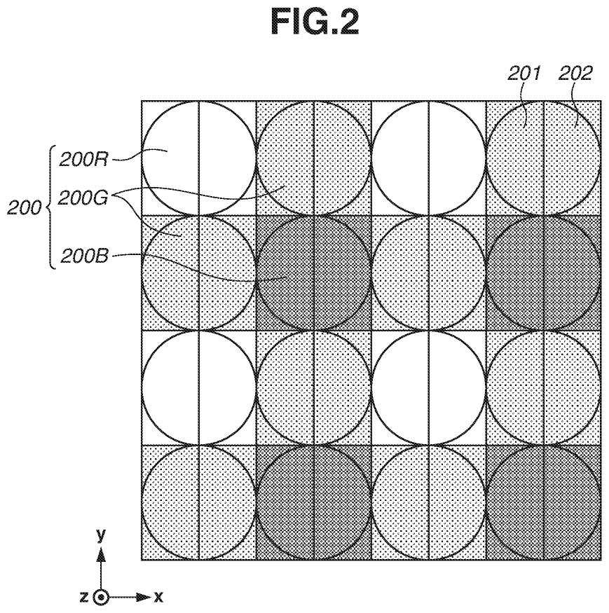

FIG. 2 is a schematic diagram illustrating an array of imaging pixels (and focus detection pixels) of the imaging element 122 according to the present exemplary embodiment. FIG. 2 illustrates a pixel (imaging pixel) array in a range of 4 columns×4 rows and a focus detection pixel array in a range of 8 columns×4 rows of a two-dimensional CMOS sensor (imaging element 122) according to the present exemplary embodiment. According to the first exemplary embodiment, in a pixel group 200 in 2 columns×2 rows illustrated in FIG. 2, a pixel 200R, which has a spectral sensitivity of red (R), is arranged at upper left, pixels 200G, which have a spectral sensitivity of green (G), are arranged at upper right and lower left, and a pixel 200B, which has a spectral sensitivity of blue (B), is arranged at lower right. Further, each pixel includes a first focus detection pixel 201 and a second focus detection pixel 202 arranged in 2 columns×1 row.

A large number of pixels of 4 columns×4 rows (focus detection pixels of 8 columns×4 rows) illustrated in FIG. 2 are arranged on a surface, so that the imaging element can acquire a captured image (a focus detection signal). According to the present exemplary embodiment, the imaging element is described as having a pixel period P of 4 μm, the number of pixels N of 5,575 horizontal columns×3,725 vertical rows=approximately 20,750,000 pixels, a column direction period PAF of the focus detection pixels of 2 μm, and the number of focus detection pixels NAF of 11,150 horizontal columns×3,725 vertical rows=approximately 41,500,000 million pixels.

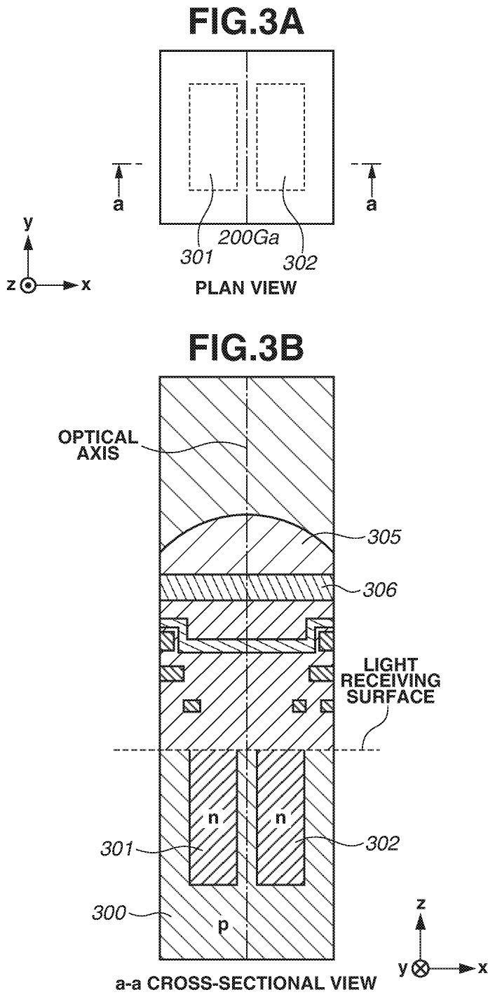

FIG. 3A is a plan view of one pixel 200G of the imaging element 122 illustrated in FIG. 2 viewed from a light receiving surface side (+z side) of the imaging element 122. FIG. 3B is a cross-sectional view of an a-a cross section in FIG. 3A viewed from a −y side.

As illustrated in FIGS. 3A and 3B, in the pixel 200G according to the present exemplary embodiment, a microlens 305 for condensing incident light is formed on a light receiving surface side of each pixel, and photoelectric conversion units 301 and 302, which are obtained by NH division (two) in an x direction and NV division (one) in a y direction, are formed. The photoelectric conversion units 301 and 302 correspond to the first focus detection pixel 201 and the second focus detection pixel 202, respectively.

Each of the photoelectric conversion units 301 and 302 may be a pin structure photodiode in which an intrinsic layer is sandwiched between a p-type layer and an n-type layer, or if appropriate, may be a pn-junction photodiode with the intrinsic layer omitted. In each pixel, a color filter 306 is formed between the microlens 305 and the photoelectric conversion units 301 and 302. In addition, spectral transmittance of the color filter 306 may be changed for each subpixel, or the color filter 306 may be omitted, if appropriate.

The light incident on the pixel 200G illustrated in FIGS. 3A and 3B is condensed by the microlens 305, divided by the color filter 306, and then received by the photoelectric conversion units 301 and 302. In the photoelectric conversion units 301 and 302, pairs of electrons and holes are generated according to an amount of received light and are separated in a depletion layer. Then, negatively charged electrons are accumulated in the n-type layers, while the holes are discharged to the outside of the imaging element 122 through the p-type layer connected to a constant voltage source (not illustrated). The electrons accumulated in the n-type layers (not illustrated) of the photoelectric conversion units 301 and 302 are transferred to an electrostatic capacitance unit (FD) via a transfer gate and converted into voltage signals.

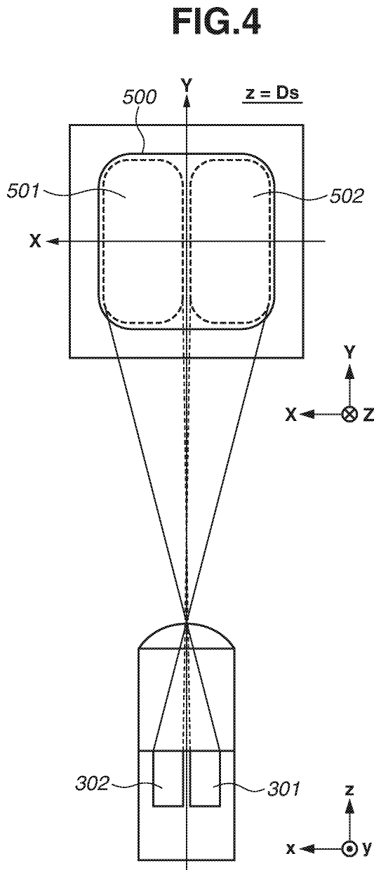

FIG. 4 is a schematic diagram illustrating a correspondence relationship between the pixel structure according to the present exemplary embodiment illustrated in FIGS. 3A and 3B and pupil division. FIG. 4 illustrates a cross-sectional view of the a-a cross section of the pixel structure according to the present exemplary embodiment illustrated in FIG. 3A viewed from a +y side, and a pupil plane (a pupil distance DS) of the imaging element 122. In FIG. 4, x- and y-axes of the cross-sectional view are inverted with respect to the x- and y-axes of FIGS. 3A and 3B in order to correspond to coordinate axes of the pupil plane of the imaging element 122.

In FIG. 4, a first pupil partial area 501 of the first focus detection pixel 201 has a substantially conjugate relationship with a light receiving surface of the photoelectric conversion unit 301 of which a center of gravity is eccentric in a-x direction due to the microlens, and represents a pupil area where the first focus detection pixel 201 can receive light. The first pupil partial area 501 of the first focus detection pixel 201 has a center of gravity eccentric to a +x side on the pupil plane. In FIG. 4, a second pupil partial area 502 of the second focus detection pixel 202 has a substantially conjugate relationship with a light receiving surface of the photoelectric conversion unit 302 of which a center of gravity is eccentric in a +x direction due to the microlens, and represents a pupil area where the second focus detection pixel 202 can receive light. The second pupil partial area 502 of the second focus detection pixel 202 has a center of gravity eccentric to a −x side on the pupil plane. Further, in FIG. 4, a pupil area 500 is a pupil area where the entire pixel 200G can receive light when the photoelectric conversion units 301 and 302 (the first focus detection pixel 201 and the second focus detection pixel 202) are combined.

The imaging plane phase difference AF is affected by diffraction since the microlens of the imaging element is used to perform pupil division. In FIG. 4, the pupil distance of the imaging element to the pupil plane is several tens of millimeters, while a diameter of the microlens is several micrometers. Thus, an aperture value of the microlens will be several tens of thousands, resulting in diffraction blur at the level of several tens of millimeters. Accordingly, an image on the light receiving surface of the photoelectric conversion unit has a light receiving sensitivity characteristic (incident angle distribution of light receiving rate) because the pupil area and the pupil partial area are unclear.

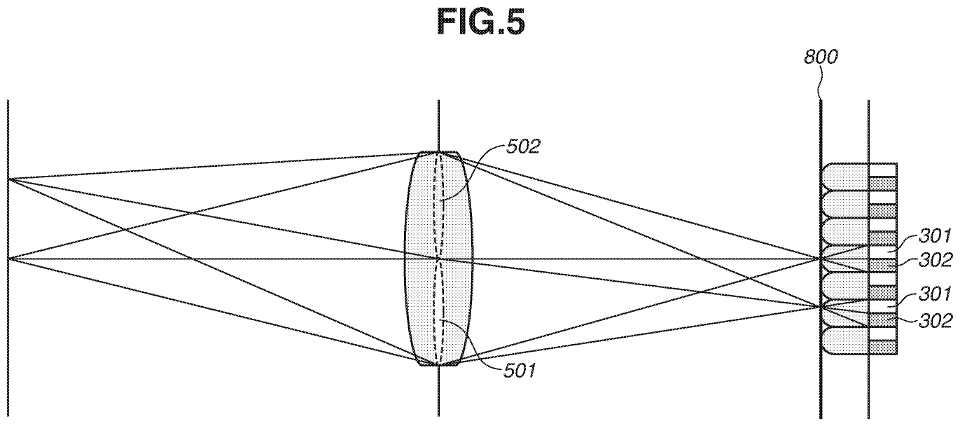

FIG. 5 is a schematic diagram illustrating a correspondence relationship between the imaging element 122 and the pupil division according to the present exemplary embodiment. Light fluxes passing through different pupil partial areas of the first pupil partial area 501 and the second pupil partial area 502 are incident on each pixel in the imaging element at different angles and are received by the first focus detection pixel 201 and the second focus detection pixel 202, which are obtained by dividing each pixel into 2×1. According to the present exemplary embodiment, an example is described in which the pupil area is divided into two pupils in the horizontal direction. If necessary, pupil division may be performed in the vertical direction.

In the imaging element 122 according to the present exemplary embodiment, a plurality of imaging pixels each including the first focus detection pixel 201 and the second focus detection pixel 202 is arranged. The first focus detection pixel 201 receives the light flux passing through the first pupil partial area 501 of the imaging optical system. The second focus detection pixel 202 receives the light flux passing through the second pupil partial area 502 of the imaging optical system that is different from the first pupil partial area 501. Further, the imaging pixel receives the light fluxes passing through the pupil area combining the first pupil partial area 501 and the second pupil partial area 502 of the imaging optical system.

In the imaging element 122 according to the present exemplary embodiment, each imaging pixel includes the first focus detection pixel 201 and the second focus detection pixel 202. If necessary, the imaging pixel, the first focus detection pixel 201, and the second focus detection pixel 202 may be configured as separate pixels, and the first focus detection pixel 201 and the second focus detection pixel 202 may be partially arranged in a part of an imaging pixel array.

According to the present exemplary embodiment, light reception signals from the first focus detection pixels 201 of the pixels in the imaging element 122 are collected to generate a first focus signal, light reception signals from the second focus detection pixels 202 of the pixels are collected to generate a second focus signal, and focus detection is performed. Further, signals of the first focus detection pixel 201 and the second focus detection pixel 202 are added for each pixel of the imaging element 122, thereby generating an imaging signal (captured image) with a resolution of effective number of pixels N. A method for generating each signal is not limited to that according to the first exemplary embodiment, and, for example, the second focus detection signal may be generated from a difference between the imaging signal and the first focus signal.

A relationship between a defocus amount and an image shift amount of the first focus detection signal and the second focus detection signal acquired by the imaging element 122 according to the first exemplary embodiment is described below.

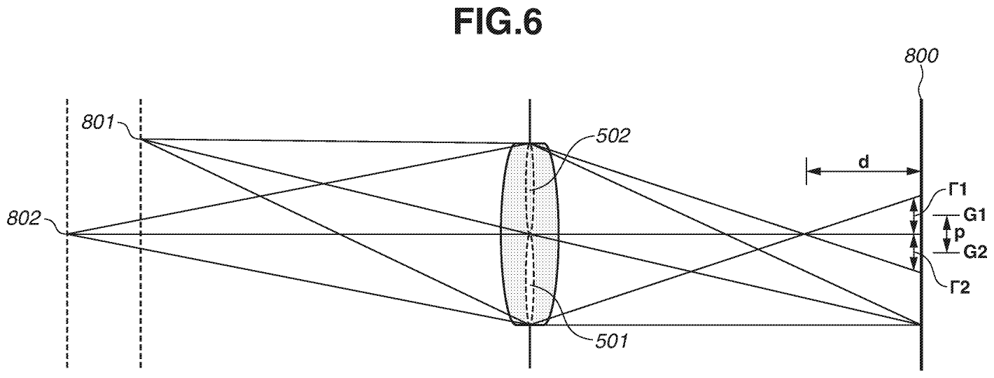

FIG. 6 is a schematic diagram illustrating a relationship between a defocus amount of the first focus detection signal and the second focus detection signal and an image shift amount between the first focus detection signal and the second focus detection signal. The imaging element 122 according to the first exemplary embodiment (not illustrated in FIG. 6) is arranged on an imaging plane 800, and the pupil plane of the imaging element 122 is divided into two, the first pupil partial area 501 and the second pupil partial area 502, as in FIGS. 4 and 5. A defocus amount d is defined as a distance from the image forming position of an object to the imaging plane as a magnitude |d|. The defocus amount d is defined to be negative (d<0) in a case of a front focus state in which the image forming position of an object is located closer to the object than the imaging plane. Further, the defocus amount d is defined to be positive (d>0) in a case of a back focus state in which the image forming position of an object is located farther away from the object than the imaging plane. A focus state in which the image forming position of an object is on the imaging plane (focus position) is defined as d=0. FIG. 6 illustrates an example in which an object 801 is in the focus state (d=0) and an object 802 is in the front focus state (d<0). The front focus state (d<0) and the back focus state (d>0) are collectively referred to as a defocus state (|d|>0).

In the front focus state (d<0), the light flux passing through the first pupil partial area 501 (the second pupil partial area 502) of the light flux from the object 802 is once condensed, then spreads to a width Γ1 (Γ2) centering on a gravity center position G1 (G2) of the light fluxes, and forms a blurred image on the imaging plane 800. The blurred image is received by the first focus detection pixel 201 (the second focus detection pixel 202) included in each pixel arranged in the imaging element 122, and the first focus detection signal (the second focus detection signal) is generated. Thus, the first focus detection signal (the second focus detection signal) is recorded as an object image in which the object 802 is blurred in the width Γ1 (Γ2) centering on the gravity center position G1 (G2) on the imaging plane 800. The blur width Γ1 (Γ2) of the object image generally increases in proportion to an increase in the magnitude |d| of the defocus amount d. Similarly, a magnitude |p| of an image shift amount p (=a difference G1−G2 between gravity center positions of the light fluxes) of the object image between the first focus detection signal and the second focus detection signal also generally increases in proportion to an increase in the magnitude |d| of the defocus amount d. The same is true in the back focus state (d>0), although an image shift direction of the object image between the first focus detection signal and the second focus detection signal is opposite to that in the front focus state.

As the first focus detection signal and the second focus detection signal, or the magnitude of the defocus amount of the imaging signal obtained by adding the first focus detection signal and the second focus detection increase, the magnitude of the image shift amount between the first focus detection signal and the second focus detection signal increases. Thus, in the phase difference AF unit 129 according to the first exemplary embodiment, as the defocus amount of the imaging signal increases, the magnitude of the image shift amount between the first focus detection signal and the second focus detection signal increases. In other words, the image shift amount is converted into a detected defocus amount using a conversion coefficient calculated based on a base length.

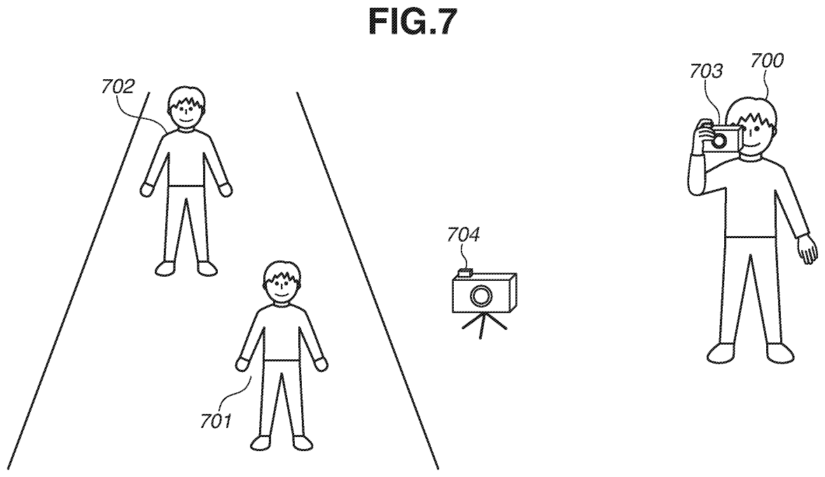

Operation flows according to the present exemplary embodiment are described below with reference to FIGS. 7 to 10.

A use scene according to the present exemplary embodiment is described using a scene illustrated in FIG. 7. In FIG. 7, a user 700, a main object 701 as an imaging target of the user 700, and another object 702 within the same angle of view as the main object 701 exist in the scene. In addition, the user 700 is trying to capture images of the main object 701 using a handheld imaging camera 703 and a remote imaging camera 704. Here, according to the present exemplary embodiment, both the handheld imaging camera 703 and the remote imaging camera 704 are described as having a configuration similar to that of the imaging apparatus 10. The remote imaging camera 704 is not limited to this configuration, and may be a stationary type camera that can communicate with the handheld imaging camera 703.

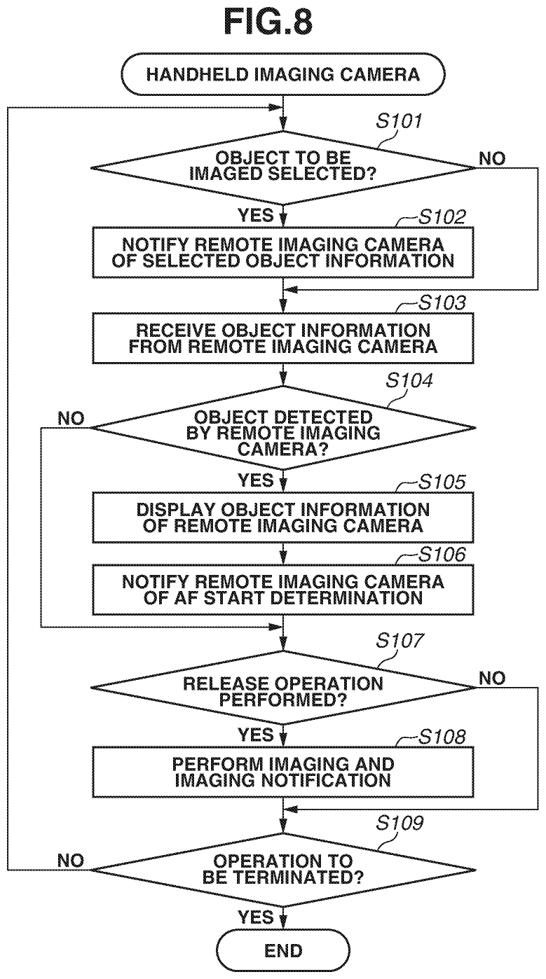

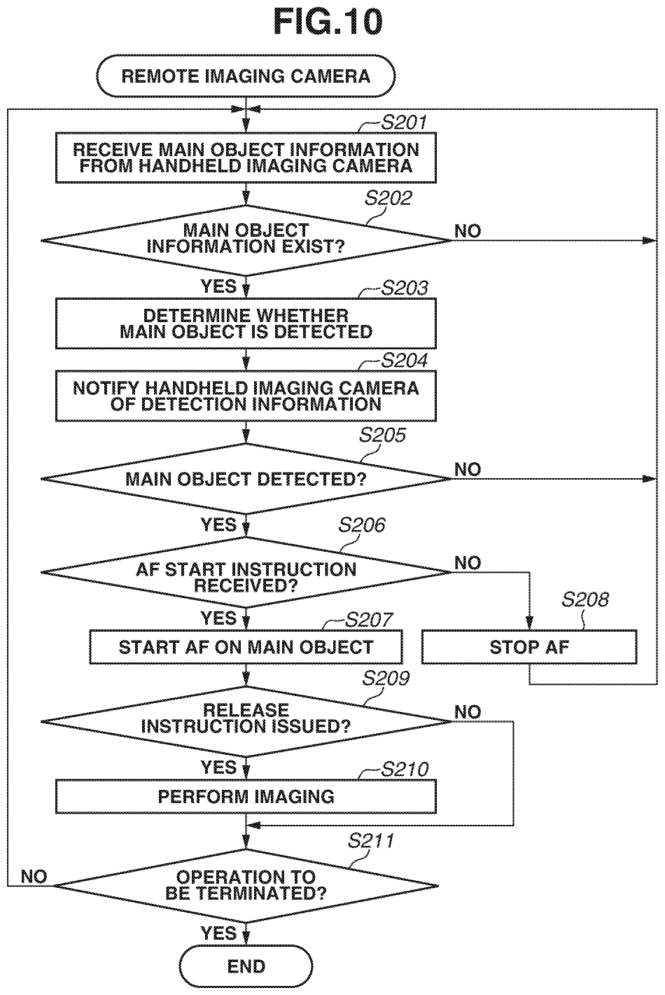

The flows of operations performed by the handheld imaging camera 703 and the remote imaging camera 704 according to the present exemplary embodiment are described with reference to flowcharts in FIGS. 8 and 10. Each step in the flowcharts is executed by a CPU in the handheld imaging camera 703 and a CPU in the remote imaging camera 704 reading programs and controlling each unit in the handheld imaging camera 703 and the remote imaging camera 704.

First, in step S101, the user 700 selects an object of which image the user 700 wants to capture. Specifically, the user 700 captures the main object 701 within the angle of view using the handheld imaging camera 703, and the main object 701 detected as an object by the object detection unit 130 is designated as an imaging object. In addition, it is also possible to register information (a feature amount) about a face of an individual and the like in advance and, in a case where a specific registered face is detected within the angle of view (if a certain degree of similarity is satisfied), to specify the face as a main object.

In a case where the object to be imaged is selected (YES in step S101), the processing proceeds to step S102. If the object to be imaged is not selected due to the reason that, for example, any object does not exist in the angle of view of the handheld imaging camera 703 (NO in step S101), the processing proceeds to step S103.

Next, in step S102, the handheld imaging camera 703 notifies the remote imaging camera 704 of object information about the object selected in step S101 via the object synchronization information transmission and reception unit 131. The object information at this time is information about the main object 701 captured by the handheld imaging camera 703, such as the feature amount of the object detected by the object detection unit 130. The object information is extracted by a feature amount extraction unit (not illustrated).

In step S103, the handheld imaging camera 703 receives the object information transmitted from the remote imaging camera 704 via the object synchronization information transmission and reception unit 131. The information that the handheld imaging camera 703 receives here is the object information detected by the object detection unit 130 in the remote imaging camera 704 and is the information transmitted from the object synchronization information transmission and reception unit 131 in the remote imaging camera 704.

In step S104, the handheld imaging camera 703 determines whether the object information notified from the handheld imaging camera 703 to the remote imaging camera 704 in step S102 matches the information notified from the remote imaging camera 704 to the handheld imaging camera 703 in step 103. In other words, the handheld imaging camera 703 determines whether the remote imaging camera 704 detects the object intended on the handheld imaging camera 703 side. If the object is detected (YES in step S104), the processing proceeds to step S105, and if the object is not detected (NO in step S104), the processing proceeds to step S107.

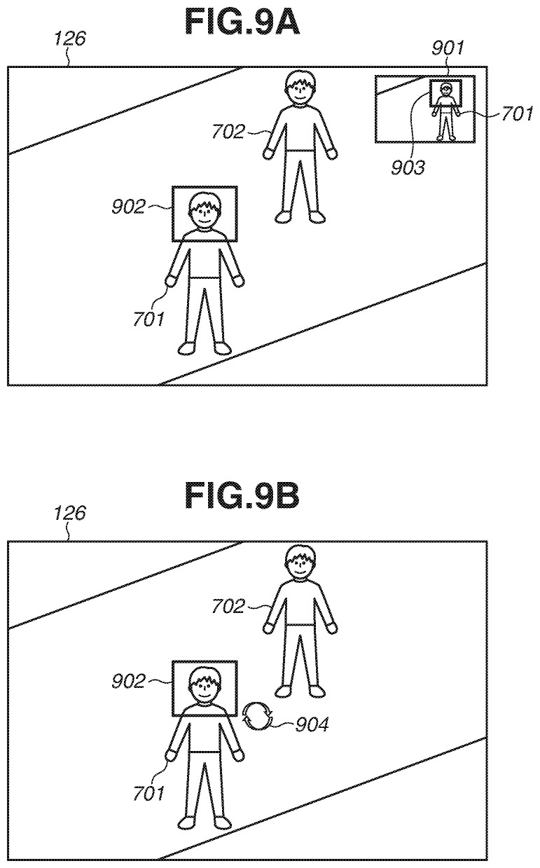

In step S105, the handheld imaging camera 703 notifies the user 700 who is using the handheld imaging camera 703 of an object detection state of the remote imaging camera 704 so that the user 700 can recognize it. A notification method at this time is, for example, a method for vibrating the vibration unit 132 of the handheld imaging camera 703. Further, the speaker unit 133 may make a notification by sound instead of vibration. Furthermore, the notification may be made by displaying an icon or a message on the display device 126 of the handheld imaging camera 703. A display method at this time is described with reference to FIGS. 9A and 9B.

In a case where the handheld imaging camera 703 detects the main object 701 in the angle of view displayed in the display device 126, a rectangular frame 902 is displayed to indicate that the handheld imaging camera 703 detects the main object 701. In FIG. 9A, an image 901 captured by the remote imaging camera 704 is displayed in an upper right portion of the display device 126, and a rectangular frame 903 is displayed to indicate that the remote imaging camera 704 detects the main object 701. Accordingly, the user 700 can confirm that the remote imaging camera 704 has detected the main object 701. As another specification, an icon 904 indicating that the remote imaging camera 704 has detected the main object 701 may be displayed together with the rectangular frame 902 for the handheld imaging camera 703 as illustrated in FIG. 9B so as to notify the user 700 that the remote imaging camera 704 has detected the main object 701.

In step S106, the CPU in the handheld imaging camera 703 determines whether the handheld imaging camera 703 starts AF with respect to the detected main object 701 and notifies the remote imaging camera 704 of a determination result via the object synchronization information transmission and reception unit 131. The determination as to whether to start AF is performed based on, for example, whether the user 700 performs a predetermined operation on the handheld imaging camera 703, such as half pressing the release (imaging trigger) switch (focus adjustment instruction).

In step S107, the CPU in the handheld imaging camera 703 determines whether a release operation (full pressing, namely an imaging instruction) is performed on the handheld imaging camera 703. If the release operation is performed (YES in step S107), the processing proceeds to step S108, and if the release operation is not performed (NO in step S107), the processing proceeds to step S109.

In step S108, the handheld imaging camera 703 starts an imaging operation, and at the same time performs processing for notifying the remote imaging camera 704 of the imaging via the object synchronization information transmission and reception unit 131.

In step S109, the handheld imaging camera 703 determines whether to terminate the operation. If the operation is determined to be continued in the handheld imaging camera 703 (NO in step S109), the processing returns to step S101, and if the operation is determined to be not continued (YES in step S109), the flow of processing is terminated.

The flow of processing performed by the handheld imaging camera 703 is described above.

Next, the flow of processing performed by the remote imaging camera 704 is described with reference to the flowchart in FIG. 10. Each step in the flowchart is executed by the CPU in the remote imaging camera 704 reading a program and controlling each unit in the remote imaging camera 704.

First, in step S201, the remote imaging camera 704 receives main object information from the handheld imaging camera 703 via the object synchronization information transmission and reception unit 131. The main object information is the information notified from the handheld imaging camera 703 to the remote imaging camera 704 in step S102.

In step S202, the remote imaging camera 704 determines whether the main object information exists in the information notified from the handheld imaging camera 703 in step S201. If the main object information does not exist (NO in step S202), the processing returns to step S201, and if the main object information exists (YES in step S202), the processing proceeds to step S203.

In step S203, the remote imaging camera 704 determines whether the main object (701) corresponding to the main subject information received in step S201 among the objects (the objects 701 and 702 in this case) detected by the object detection unit 130 in the remote imaging camera 704 is detected based on a detection result by the object detection unit 130 in the remote imaging camera 704.

In step S204, the remote imaging camera 704 notifies the handheld imaging camera 703 of the detection result in step S203. The detection result is the information that the handheld imaging camera 703 receives in step S103.

In step S205, the remote imaging camera 704 determines whether the main object 701 is detected in step S203. If the main object 701 is not detected (NO in step S205), the processing returns to step S201, and if the main object 701 is detected (YES in step S205), the processing proceeds to step S206.

In step S206, the remote imaging camera 704 determines whether an AF start instruction is received from the handheld imaging camera 703 via the object synchronization information transmission and reception unit 131. The information is the information notified from the handheld imaging camera 703 to the remote imaging camera 704 in step S106 and is information about timing at which the user 700 wants to focus on the main object 701 in the remote imaging camera 704. If the AF start instruction is received (YES in step S206), the processing proceeds to step S207, and if the AF start instruction is not received (NO in step S206), the processing proceeds to step S208.

In step S207, the remote imaging camera 704 performs AF on the main object 701 detected in step S206 based on the defocus amount calculated by the phase difference AF unit 129 of the remote imaging camera 704.

In step S208, the remote imaging camera 704 does not start AF, and stops the focus actuator 113 for performing AF if AF is already started.

In a case where AF is stopped, the focus actuator 113 may be stopped at a current position or moved to a position set in advance and then stopped.

In step S209, the remote imaging camera 704 determines whether a release instruction is issued from the handheld imaging camera 703 in step S107. If the release instruction is issued (YES in step S209), the processing proceeds to step S210, and if the release instruction is not issued (NO in step S209), the processing proceeds to step S211.

In step S210, the remote imaging camera 704 performs imaging based on the release instruction in step S209.

In step S211, the remote imaging camera 704 determines whether to continue the operation. If the operation is determined to be continued (NO in step S211), the processing returns to step S201, and if the operation is determined to be not continued (YES in step S211), the flow of processing is terminated.

With the above-described configuration, in a scene in which a user wants to capture images of the same object using a handheld imaging camera and a remote imaging camera, it is possible to accurately reflect a user's intention on the remote imaging camera.

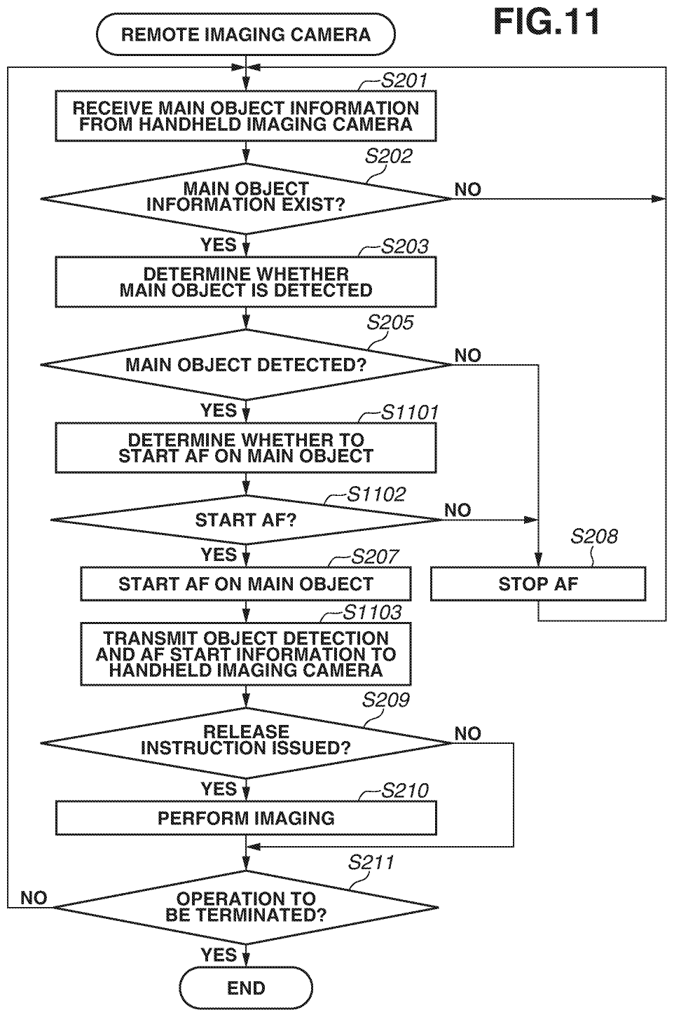

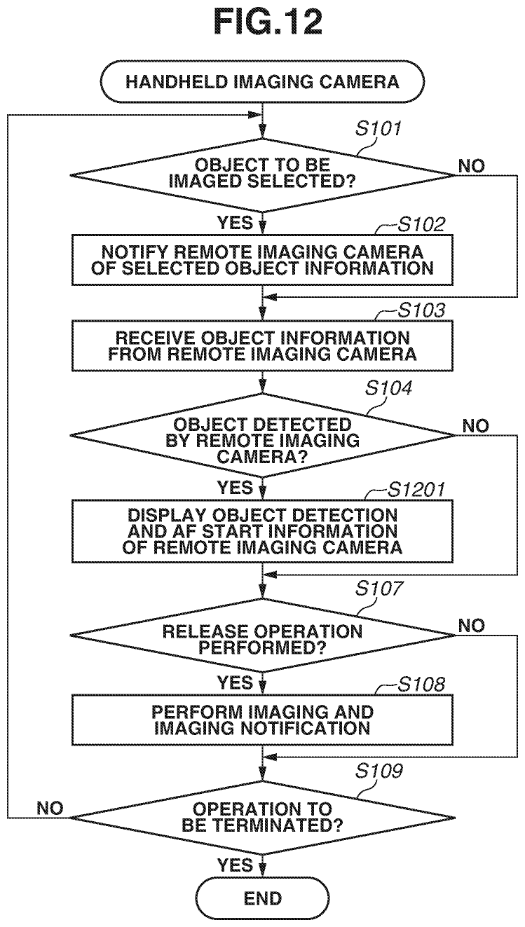

Next, an operation flow according to a second exemplary embodiment of the present disclosure is described with reference to FIGS. 11 and 12. According to the first exemplary embodiment, an AF start timing is instructed from the handheld imaging camera 703 to the remote imaging camera 704, but according to the second exemplary embodiment, an AF start timing is determined in the remote imaging camera 704. According to the first exemplary embodiment, in a scene in which an object moves in a complicated manner, it is better that a user determines an AF start timing using the handheld imaging camera 703 and instructs the remote imaging camera 704 from the handheld imaging camera 703. On the other hand, in a scene in which an object gently moves, the remote imaging camera 704 is caused to determine the AF start timing. Accordingly, the imaging load on the user who operates the handheld imaging camera 703 can be reduced. A use scene according to the second exemplary embodiment is the same as that illustrated in FIG. 7, in which use scene, the user 700 operates the handheld imaging camera 703 and the remote imaging camera 704 and captures images of the object 701 as the main object among the objects 701 and 702.

According to the second exemplary embodiment, the operation flow of the remote imaging camera 704 is described first with reference to FIG. 11. Each step in the flowchart is executed by the CPU in the remote imaging camera 704 reading a program and controlling each unit in the remote imaging camera 704.

Processing in steps S201 to S205 is the same as that according to the first exemplary embodiment. In step S205, if the main object 701 is detected (YES in step S205), the processing proceeds to step S1101, and if the main object 701 is not detected (NO in step S205), the processing proceeds to step S208.

In step S1101, the CPU in the remote imaging camera 704 determines whether to start AF on the main object 701 detected in step S203 in the remote imaging camera 704, based on a predetermined condition. The foregoing determination may be made based on reliability of detection by the object detection unit 130 of the remote imaging camera 704 in step S203, or may be made based on reliability of the defocus amount calculation of the main object position. Further, it may be determined whether to start AF depending on a distance between the remote imaging camera 704 and the main object 701.

In step S1102, if AF is started in response to AF start determination by the remote imaging camera 704 in step S1101 (YES in step S1102), the processing proceeds to step S207, and if AF is stopped (NO instep S1102), the processing proceeds to step S208.

Processing in steps S207 and S208 is the same as that according to the first exemplary embodiment.

In step S1103, the remote imaging camera 704 notifies the handheld imaging camera 703 of a detection result indicating whether the remote imaging camera 704 detects the main object 701 in step S203 and a determination result indicating whether the remote imaging camera 704 starts AF in step S1101 using the object synchronization information transmission and reception unit 131.

Processing in steps S209 to S211 is also the same as that according to the first exemplary embodiment.

Next, the operation flow of the handheld imaging camera 703 is described with reference to FIG. 12.

Processing in steps S101 to S104 is the same as that according to the first exemplary embodiment.

In step S1201, an object detection state and an AF start state of the remote imaging camera 704 notified in step S1103 are displayed. Display similar to that illustrated in FIGS. 9A and 9B according to the first exemplary embodiment is displayed at this time. According to the second exemplary embodiment, the remote imaging camera 704 determines whether to perform AF within itself in step S1101, so that the user does not need to perform processing for determining whether to start AF for the remote imaging camera 704 using the handheld imaging camera 703. The processing then proceeds to step S107.

Processing in steps S107 to S109 is the same as that according to the first exemplary embodiment.

With the above-described configuration, in a scene in which a user wants to capture images of the same object using a handheld imaging camera and a remote imaging camera, it is possible to accurately reflect a user's intention on the remote imaging camera.

### Other Exemplary Embodiments

The present disclosure can also be implemented by executing processing in which a program for realizing one or more functions of the above-described exemplary embodiments is supplied to a system or an apparatus via a network or a storage medium and one or more processors in a computer of the system or the apparatus read and execute the program. The present disclosure can also be implemented by a circuit (for example, an application specific integrated circuit (ASIC)) for implementing one or more functions.

The present disclosure is not limited to the above-described exemplary embodiments, and various modifications and changes can be made without departing from the spirit and the scope of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-024899, filed Feb. 21, 2023, which is hereby incorporated by reference herein in its entirety.

What is claimed is:

1. An apparatus comprising:
an image sensor;
an operation member configured to receive an instruction;
a communicator configured to communicate with another apparatus; and
one or more processors that execute a program stored in a memory to function as:
an acquisition unit configured to acquire an image;
a detection unit configured to detect objects from the image; and
a selection unit configured to select at least one of the objects as a main object,
wherein, in a case where the selected main object is detected in the another apparatus, the communicator also transmits the instruction issued to the operation member to the another apparatus.

2. The apparatus according to claim 1, wherein, if a focus adjustment instruction is issued to the operation member, the communicator transmits to the another apparatus an instruction to perform focus adjustment on the main object.

3. The apparatus according to claim 5, wherein, if an imaging instruction is issued to the operation member, the communicator transmits to the another apparatus an instruction to perform imaging.

4. The apparatus according to claim 1, wherein execution of the stored instructions further configures the processor to function as a registration unit configured to register a specific object,
wherein, in a case where the detection unit detects the specific object, the selection unit determines the specific object as the main object.

5. The apparatus according to claim 1, wherein execution of the stored instructions further configures the processor to function as an extraction unit configured to extract a feature amount from the image, and
wherein the selection unit determines the main object based on similarity of the feature amount acquired by the extraction unit.

6. The apparatus according to claim 1, wherein execution of the stored instructions further configures the processor to function as a notification unit configured to make a notification to a user, and
wherein the notification unit notifies the user of whether the main object is detected in the another apparatus.

7. The apparatus according to claim 6, wherein the notification unit makes the notification by vibration or sound.

8. The apparatus according to claim 6, further comprising a display unit configured to display an image,
wherein the notification unit makes the notification using the display unit.

9. The apparatus according to claim 8, wherein the notification unit makes the notification by displaying an image of the main object captured by the another apparatus on the display unit.

10. The apparatus according to claim 1, wherein the another apparatus is a camera for performing remote imaging.

11. A method for controlling an apparatus, the method comprising:
acquiring an image;
detecting objects from the image;
selecting at least one of the objects as a main object;
receiving an instruction; and
communicating with another apparatus,
wherein, in a case where the another apparatus detects the selected main object, the instruction is also transmitted to the another apparatus in the communicating.

12. A non-transitory computer-readable storage medium storing instructions that, when executed by a processor of an apparatus, configures the processor of the apparatus to perform a method, the method comprising:
acquiring an image;
detecting objects from the image;
selecting at least one of the objects as a main object;
receiving an instruction; and
communicating with another apparatus,
wherein, in a case where the another apparatus detects the selected main object, the instruction is also transmitted to the another apparatus in the communicating.
